(19) United States
(12) Patent Application Publication
(10) Pub. No.: US 2021/0079919 A1
(43) Pub. Date: Mar. 18, 2021

(54) FLUID TRANSPORTATION DEVICE

(71) Applicant: SUNONWEALTH ELECTRIC MACHINE INDUSTRY CO., LTD., KAOHSIUNG CITY (TW)

(72) Inventors: ALEX HORNG, KAOHSIUNG CITY (TW); TSO-KUO YIN, KAOHSIUNG CITY (TW); MING-TSUNG LI, KAOHSIUNG CITY (TW)

(21) Appl. No.: 17/017,296

(22) Filed: Sep. 10, 2020

(30) Foreign Application Priority Data
Sep. 12, 2019 (TW) 108132912

(51) Int. Cl. F04D 13/06; F04D 25/06; F04D 29/58

(52) U.S. Cl. CPC F04D 13/0606; F04D 25/06; F05D 2230/72; F05D 2260/20; F05D 2230/60; F04D 29/5806

(57) ABSTRACT

The present disclosure provides a fluid transportation device. The fluid transportation device includes a casing and a fluid driving member. The casing has a first shell and a second shell divided along an axial direction. The first shell and the second shell are assembled to be opposite to each other. The casing has an accommodating space, a first transporting portion, and a second transporting portion. The first transporting portion and the second transporting portion are in communication with the accommodating space. The fluid driving member has a first fan wheel, a second fan wheel, and a motor. The first fan wheel, the second fan wheel, and the motor are disposed in the accommodating space. The motor is configured to drive the first fan wheel and the second fan wheel to rotate.

### BACKGROUND OF THE DISCLOSURE

### 1. Field of the Disclosure

The disclosure relates to a fluid transportation device.

### 2. Description of the Related Art

A conventional fluid transportation device is, for example, generally a water pump, etc., which control circular flow of a fluid such as cooling water to dissipate heat from various products that may easily generate a high temperature during operation in the market.

In addition, the conventional water pump may include many complicated elements, causing many inconveniences in assembly and maintenance of the water pump. It is still necessary to improve control of circular flow efficiency of the cooling water by the water pump.

### SUMMARY OF THE DISCLOSURE

The present disclosure provides a fluid transportation device. In an embodiment, the fluid transportation device includes a casing and a fluid driving member. The casing has a first shell and a second shell divided along an axial direction. The first shell and the second shell are assembled to be opposite to each other. The casing has an accommodating space, a first transporting portion and a second transporting portion. The first transporting portion and the second transporting portion are in communication with the accommodating space. The fluid driving member has a first fan wheel, a second fan wheel, and a motor. The first fan wheel, the second fan wheel, and the motor are disposed in the accommodating space. The motor is configured to drive the first fan wheel and the second fan wheel to rotate.

Therefore, by using the first shell and the second shell divided along the axial direction and the fluid driving member, the fluid transportation device of the present invention may provide better convenience in assembly and maintenance, and raise the circular efficiency of the fluid.

### BRIEF DESCRIPTION OF THE DRAWINGS

FIG. 1 shows a perspective diagram of a fluid transportation device according to an embodiment of the present invention.

FIG. 2 shows a perspective exploded diagram of a first shell and a second shell of the fluid transportation device according to an embodiment of the present invention.

FIG. 3 shows a perspective exploded diagram of a fluid transportation device according to an embodiment of the present invention.

FIG. 4 shows a perspective exploded diagram of a fluid driving member of the fluid transportation device according to an embodiment of the present invention.

FIG. 5 is a schematic diagram of internal assembly of the fluid transportation device without a second shell according to an embodiment of the present invention.

FIG. 6 shows a schematic top view of a fluid transportation device according to an embodiment of the present invention when a stationary blade is disposed.

FIG. 7 shows a schematic diagram of internal assembly of the fluid transportation device without a second shell according to another embodiment of the present invention.

FIG. 8 shows a schematic diagram of internal assembly of the fluid transportation device without a second shell according to still another embodiment of the present invention.

### DETAILED DESCRIPTION OF THE DISCLOSURE

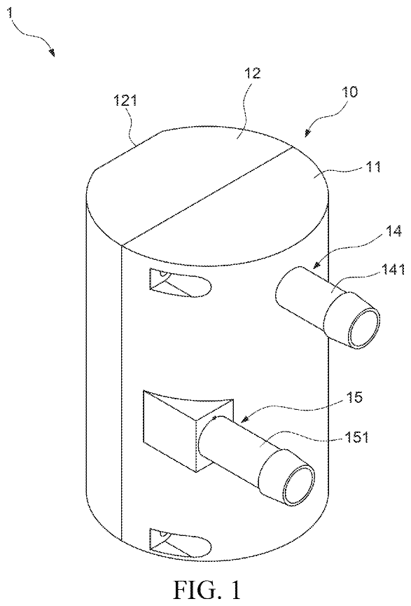

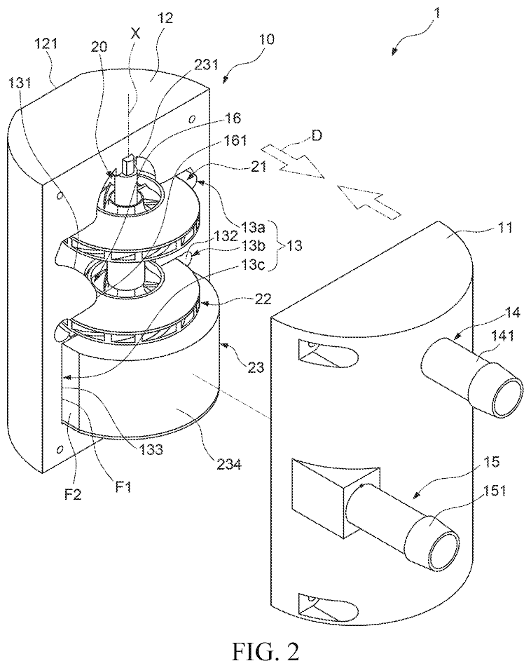

FIG. 1 shows a perspective diagram of a fluid transportation device according to an embodiment of the present invention. FIG. 2 shows a perspective exploded diagram of a first shell and a second shell of the fluid transportation device according to an embodiment of the present invention. With reference to FIG. 1 and FIG. 2, a fluid transportation device 1 of the present invention includes a casing 10 and a fluid driving member 20. The fluid transportation device 1 of the present invention may be configured to drive a fluid such as a liquid or a gas to flow, for example: The fluid transportation device 1 of the present invention may be applied to, for example, water pump, but is not limited thereto.

In an embodiment, the casing 10 of the fluid transportation device 1 of the present invention has a first shell 11 and a second shell 12 divided along an axial direction X. The first shell 11 and the second shell 12 may be assembled to be opposite to each other and have an accommodating space 13. A first transporting portion 14 and a second transporting portion 15 are disposed on the casing 10. The first transporting portion 14 and the second transporting portion 15 are in communication with the accommodating space 13. Pipes 141, 151 may be selected as the first transporting portion 14 and the second transporting portion 15. The pipes 141 and 151 may be disassembled and assembled on the casing 10 respectively. In an embodiment shown in the figure, the pipes 141 and 151 are disposed on the first shell 11. Therefore, the pipes 141, 151 may be disassembled and assembled on the casing 10 in a manner such as engagement or screw connection, so that convenience in disassembly and assembly, use, and maintenance is improved, and pipes of different sizes may be drawn and changed, thereby flexibly adjusting the sizes of the pipes.

In an embodiment, the fluid driving member 20 of the fluid transportation device 1 of the present invention has a first fan wheel 21, a second fan wheel 22, and a motor 23. The first fan wheel 21, the second fan wheel 22, and the motor 23 are disposed in the accommodating space 13, and the motor 23 is configured to drive the first fan wheel 21 and the second fan wheel 22 to rotate.

In actual use of the fluid transportation device 1 of the present invention, when the first transporting portion 14 is set as an inlet end of the fluid, the second transporting portion 15 may be set as an outlet end of the fluid. Alternatively, when the first transporting portion 14 is set as the outlet end of the fluid, the second transporting portion 15 may be set as the inlet end of the fluid, thereby improving convenience in use. In addition, the motor 23 may synchronously drive the first fan wheel 21 and the second fan wheel 22 to rotate in a predetermined direction (such as rotating clockwise or counterclockwise), to more effectively drive and pressurize the fluid to flow, thereby improving fluid transportation efficiency.

In an embodiment, the first fan wheel 21, the second fan wheel 22, and the motor 23 of the fluid driving member 20 may be assembled into an integral to be directly placed in the accommodating space 13. Through the design of the first shell 11 and the second shell 12 divided in the axial direction X, the first shell 11 and the second shell 12 may assembled to be opposite to each other (for example, assembled through screwing or engagement) in a radial assembly direction D (perpendicular to the axial direction X). Therefore, the assembled fluid driving member 20 through the integrated design is hermetically covered in the accommodating space 13 of the casing 10, providing better convenience in disassembly and assembly. In addition, the fluid driving member 20 may be further placed in the casing 10 entirely, or taken out from the casing 10 entirely to facilitate maintenance.

In an embodiment, materials of the first shell 11 and the second shell 12 of the fluid transportation device 1 of the present invention may be the same. Therefore, when the same material is used, the first shell 11 and the second shell 12 are easy to manufacture, to effectively reduce costs. Alternatively, materials of the first shell 11 and the second shell 12 may be different. In an embodiment, the material of the first shell 11 may be a transparent material or a semi-transparent material, for example, a transparent acrylic, polycarbonate (PC), polyvinyl chloride (PVC) material, or a semi-transparent acrylic, polycarbonate (PC), polyvinyl chloride (PVC) material. The second shell 12 may be made of a thermally conductive material (such as a metal material). However, the above materials are not limited thereto, and other suitable materials may still be selected. Therefore, a temperature sensing element (not shown) and a light emitting element (not shown) may be disposed in the accommodating space 13 of the casing 10. The light emitting element corresponds to the first shell 11, and the temperature sensing element is electrically coupled to a control element (not shown) to control the light emitting element. By using a see-through function of the first shell 11, the temperature sensing element may be configured to detect, for example, an operating temperature of the motor 23 or a temperature of the fluid in the accommodating space 13. When the temperature exceeds a preset value, the control element may be configured to control the light-emitting element to emit a warning light of a specific color (such as red light, etc.) to remind the user of paying attention, thereby achieving better warning control. In an embodiment, the fluid transportation device 1 of the present invention has a plurality of light-emitting elements. When the fluid transportation device 1 of the present invention is in operation, the plurality of light-emitting elements may emit light of different colors to enhance beauty and achieve a cool effect.

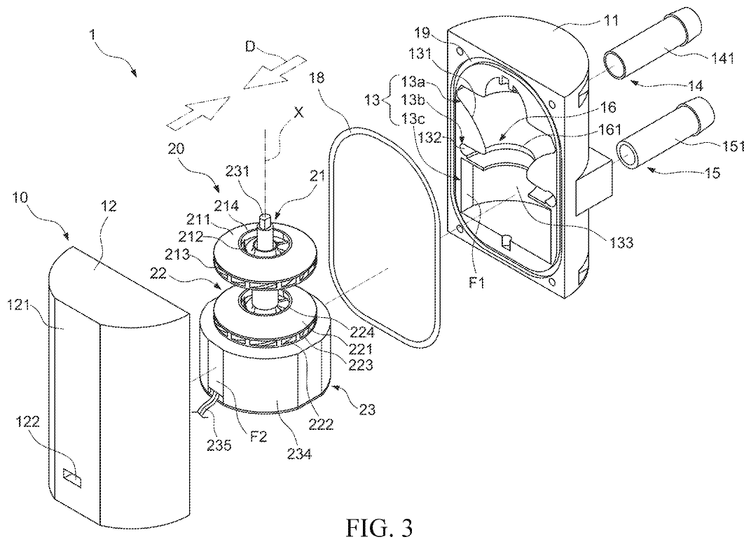

FIG. 3 shows a perspective exploded diagram of a fluid transportation device according to an embodiment of the present invention. With reference to FIG. 2 and FIG. 3, in an embodiment, a heat conducting portion 121 may be disposed on an outer peripheral wall of the second shell 12. The heat conducting portion 121 is a flat surface. Therefore, the heat conducting portion 121 of the second shell 12 may be in contact with a to-be-cooled element. Therefore, a heat conduction effect of the second shell 12 may be used to effectively reduce an operating temperature of the to-be-cooled element, thereby prolonging a service life of the to-be-cooled element.

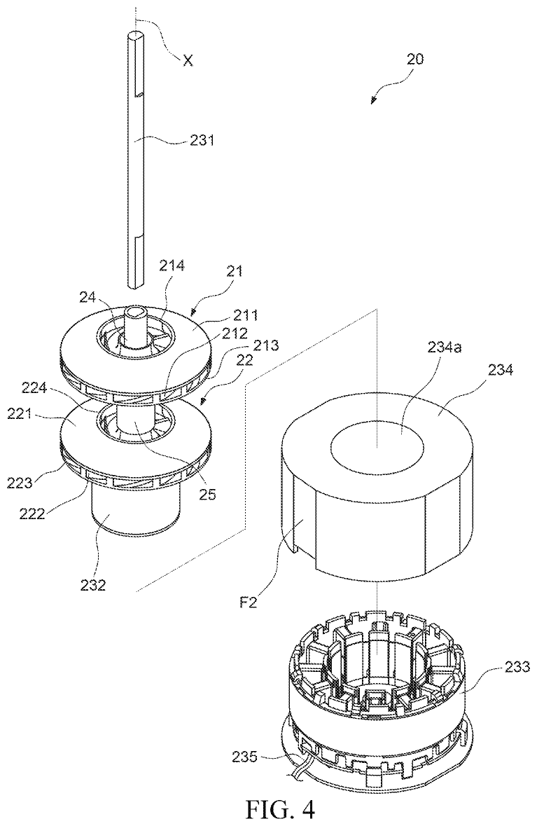

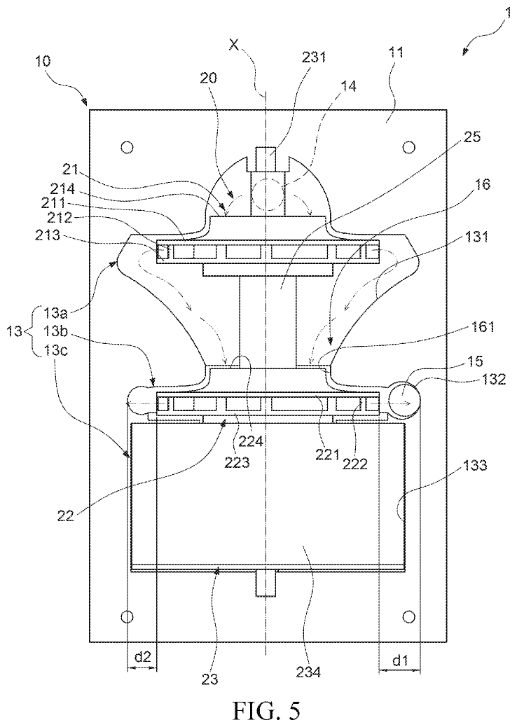

FIG. 4 shows a perspective exploded diagram of a fluid driving member of the fluid transportation device according to an embodiment of the present invention. FIG. 5 is a schematic diagram of internal assembly of the fluid transportation device without a second shell according to an embodiment of the present invention. With reference to FIG. 2 to FIG. 5, in an embodiment, a first accommodating chamber 13a, a second accommodating chamber 13b, and a third accommodating chamber 13c may be disposed in the accommodating space 13. In the axial direction X, the second accommodating chamber 13b is located between the first accommodating chamber 13a and the third accommodating chamber 13c, the first transporting portion 14 is in communication with the first accommodating chamber 13a, and the second transporting portion 15 is in communication with the second accommodating chamber 13b. The first fan wheel 21 is disposed in the first accommodating chamber 13a, the second fan wheel 22 is disposed in the second accommodating chamber 13b, and the motor 23 is disposed in the third accommodating chamber 13c. Therefore, the first accommodating chamber 13a, the second accommodating chamber 13b, and the third accommodating chamber 13c may effectively separate the first fan wheel 21, the second fan wheel 22, and the motor 23, respectively. In addition, when the first transporting portion 14 is set as the inlet end of the fluid and the second transporting portion 15 is set as the outlet end of the fluid, and when the motor 23 drives the first fan wheel 21 and the second fan wheel 22 to rotate synchronously, the first fan wheel 21 and the second fan wheel 22 may cooperate with each other to import the fluid from the first transporting portion 14, so that the fluid passes through the first accommodating chamber 13a and the second accommodating chamber 13b in sequence, and then the fluid is exported from the second transporting portion 15, to transport the fluid circularly.

A number of the fan wheels of the fluid transportation device 1 of the present invention may be set as more than two, and a number of the accommodating chambers corresponding to the number of the fan wheels may be set as more than three. For example, when the number of the fan wheels is three, the number of the accommodating chambers may be set as four. When the number of the fan wheels is four, the number of the accommodating chambers may be set as five, and the rest can be done in the same manner. Therefore, a fluid output pressure is increased.

With reference to FIG. 2, FIG. 3, and FIG. 5, in an embodiment, a pressurizing portion 16 may be disposed in the first accommodating chamber 13a for the casing 10 of the fluid transportation device 1 of the present invention, and the pressurizing portion 16 is correspondingly disposed around an outer periphery of the first fan wheel 21. Therefore, when the first fan wheel 21 imports the fluid from the first accommodating chamber 13a to the second accommodating chamber 13b, the pressurizing portion 16 may be configured to cause the fluid to flow more easily, further improving fluid transportation efficiency.

With reference to FIG. 2, FIG. 3, and FIG. 5, in an embodiment, a pressurizing channel 161 is disposed between the first accommodating chamber 13a and the second accommodating chamber 13b of the fluid transportation device 1 of the present invention. The casing 10 has a first peripheral wall 131 in the first accommodating chamber 13a. The first peripheral wall 131 is tapered toward the pressurizing channel 161 to jointly form the pressurizing portion 16. Therefore, the first peripheral wall 131 may effectively guide the fluid to flow toward the pressurizing channel 161, to effectively improve a fluid pressurizing effect of the pressurizing portion 16. In addition, the first peripheral wall 131 of the first accommodating chamber 13a may be an arc convex surface, and through the arc convex surface design, the fluid flows toward the pressurizing channel 161 more easily under guidance of the first peripheral wall 131, to smoothly enter the second accommodating chamber 13b.

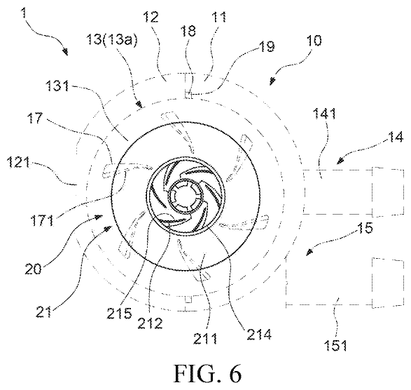

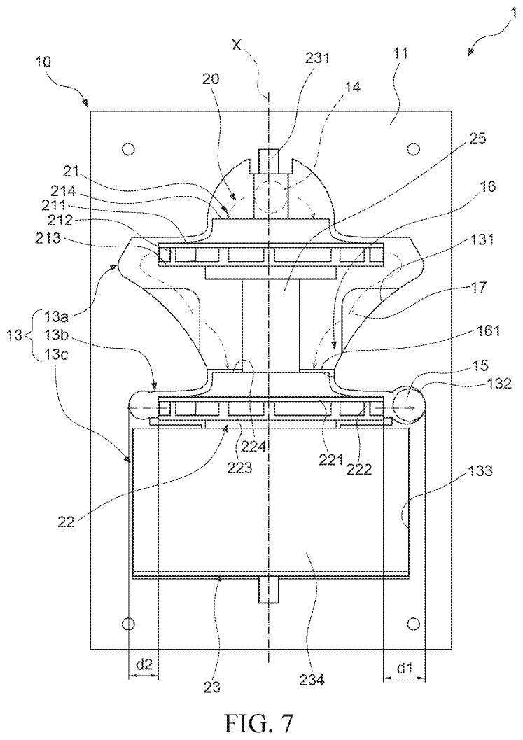

FIG. 6 shows a schematic top view of a fluid transportation device according to an embodiment of the present invention when a stationary blade is disposed. FIG. 7 shows a schematic diagram of internal assembly of the fluid transportation device without a second shell according to another embodiment of the present invention. With reference to FIG. 6 and FIG. 7, in an embodiment, at least one stationary blade 17 may be disposed on a first peripheral wall 131 of the fluid transportation device 1 of the present invention. Through design of the stationary blade 17, a fluid pressurization and guidance effect may be effectively increased in combination with the pressurizing portion 16. In addition, the stationary blade 17 may have a stationary blade driving face 171, and a plurality of blades 212 of a first fan wheel 21 each has a dynamic blade driving face 215. The stationary blade driving face 171 and the dynamic blade driving face 215 are toward different directions. When the first fan wheel 21 drives the fluid to flow, in combination with design of the stationary blade driving face 171 of the stationary blade 17, the fluid pressurization and guidance effect may be further improved.

With reference to FIG. 5, in an embodiment, the casing 10 of the fluid transportation device 1 of the present invention has a second peripheral wall 132 in the second chamber 13b. In a direction perpendicular to the axial direction X, there is a first distance d1 between an outer periphery of the second fan wheel 22 adjacent to the second transporting portion 15 and the second peripheral wall 132, and there is a second distance d2 between an outer periphery of the second fan wheel 22 away from the second transporting portion 15 and the second peripheral wall 132. The first distance d1 is greater than the second distance d2. Therefore, an adjacent area of the first distance d1 may be set as an output area, and through design that the first distance d1 is greater than the second distance d2, the adjacent area of the second distance d2 may be set as a pressurizing area. Therefore, when the second fan wheel 22 exports the fluid from the second accommodating chamber 13b to the second transporting portion 15, the pressurizing area may be used to generate a centrifugal pressurization effect, thereby smoothly driving the fluid to be exported from the second transporting portion 15 through the output area, further improving the fluid transportation efficiency.

With reference to FIG. 2 and FIG. 3, in an embodiment, the casing 10 of the fluid transportation device 1 of the present invention has a third peripheral wall 133 in the third accommodating chamber 13c. At least one first positioning portion F1 is disposed on the third peripheral wall 133, and at least one second positioning portion F2 is disposed on the motor 23. The first positioning portion F1 and the second positioning portion F2 are positioned corresponding to each other to ensure that the motor 23 does not rotate randomly in the third accommodating chamber 13c. In addition, the first positioning portion F1 and the second positioning portion F2 are respectively planes that may be abutted against each other. Therefore, the first positioning portion F1 and the second positioning portion F2 may be attached to each other more closely to provide a better anti-rotation positioning function for the motor 23.

With reference to FIG. 2 to FIG. 5, in an embodiment, the motor 23 of the fluid transportation device 1 of the present invention has a central shaft 231, a permanent magnet 232, and a stator 233. In the axial direction X, the central shaft 231 may penetrate through the first fan wheel 21, the second fan wheel 22, and the stator 233, so that two opposite ends of the central shaft 231 may be fixed in the accommodating space 13, and a radial cross section of the two opposite ends of the central shaft 231 may be a non-circular shape, ensuring that the central shaft 231 may be fixed and not rotated and the permanent magnet 232 is combined with the first fan wheel 21 and the second fan wheel 22. When the stator 233 is electrified, the electrified stator may generate alternating excitation with the permanent magnet 232, thereby driving the first fan wheel 21, the second fan wheel 22, and the permanent magnet 232 to rotate with the central shaft 231 as a center.

With reference to FIG. 3 and FIG. 4, in an embodiment, the fluid transportation device 1 of the present invention further includes a waterproof member 234 to cover the stator 233, effectively preventing the stator 233 from being damaged due to moisture during use. Alternatively, the fluid transportation device further includes a waterproof glue to cover the stator 233 (that is, covering a related electronic element of the stator). Alternatively, the waterproof member 234 is directly used as a glue filling mold of the waterproof glue, so that after the waterproof glue covers the relevant electronic element of the stator 233, the waterproof member 234 may be removed, thereby providing a better moisture-proof effect. In addition, the waterproof member 234 may not be removed, so that the waterproof member 234 covers the waterproof glue to improve the moisture-proof effect. In addition, the foregoing second positioning portion F2 may be optionally disposed on an outer peripheral wall of the waterproof member 234, and an accommodating groove 234a is disposed for the waterproof member 234 to accommodate the permanent magnet 232, so that the permanent magnet 232 may rotate smoothly relative to the stator 233 in the accommodating groove 234a.

With reference to FIG. 3, in an embodiment, a power line 235 may disposed for the stator 233 of the fluid transportation device 1 of the present invention, a line outlet 122 may be disposed in the second shell 12, and the power line 235 may penetrate through the line outlet 122, to facilitate that the power line 235 is configured to be connected to a control circuit or a driving circuit after penetrating through the line outlet 122 to outside of the casing 10. The line outlet 122 may further provide a better limiting effect for the power line 235 to prevent pulling and achieve positioning.

With reference to FIG. 4, in an embodiment, the first fan wheel 21 and the second fan wheel 22 of the fluid transportation device 1 of the present invention are rotatably combined with the central shaft 231, and at least one bearing 24 may be disposed between the first fan wheel 21 and the second fan wheel 22 and the central shaft 231. For example, one bearing 24 may be respectively disposed between the first fan wheel 21 and the second fan wheel 22 and the central shaft 231, or a single long bearing 24 directly contacting the first fan wheel 21 and the second fan wheel 22 may be disposed. The bearing 24 may be a plastic bearing or a ceramic bearing. Through design of the bearing 24, the first fan wheel 21 and the second fan wheel 22 may more smoothly rotate stably with the central shaft 231 as a center provided that the central shaft 231 is fixed.

With reference to FIG. 3 to FIG. 5, in an embodiment, the first fan wheel 21 and the second fan wheel 22 of the fluid transportation device 1 of the present invention each have an upper cover 211, 221, a plurality of blades 212, 222, and a lower cover 213, 223. The plurality of blades 212, 222 are respectively disposed between the upper covers 211, 221 and the lower covers 213, 223. The upper covers 211, 221 of the first fan wheel 21 and the second fan wheel 22 each form openings 214 and 224. When the motor 23 drives the first fan wheel 21 and the second fan wheel 22 to rotate simultaneously, the first fan wheel 21 may import the fluid from the first transporting portion 14 into the first accommodating chamber 13a. At this time, the fluid may enter between the blades 212 through the opening 214 of the upper cover 211 of the first fan wheel 21. By using a rotation guide effect of the first fan wheel 21, the fluid is driven to the pressurizing portion 16 for pressurization, and then the fluid may enter the second accommodating chamber 13b through the pressurizing channel 161. Similarly, at this time, the fluid may enter between the blades 222 through the opening 224 of the upper cover 221 of the second fan wheel 22. By using a rotation guide effect of the second fan wheel 22, the fluid is driven to be exported from the second transporting portion 15 to better transport the fluid circularly.

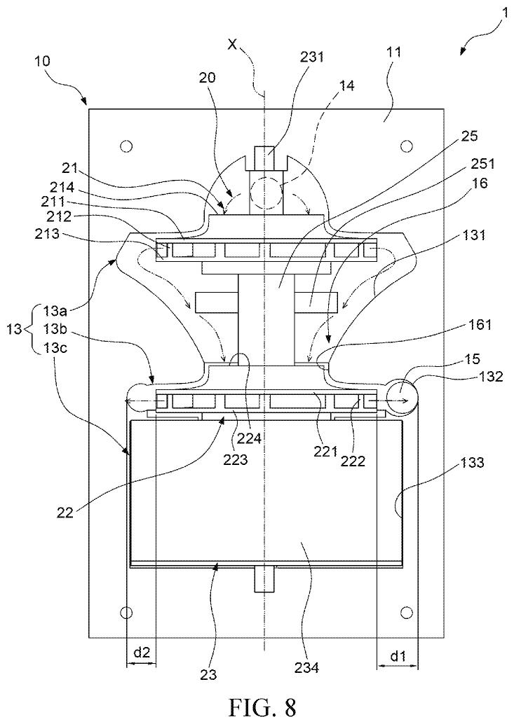

With reference to FIG. 4, in an embodiment, the first fan wheel 21 and the second fan wheel 22 of the fluid transportation device 1 of the present invention are connected to each other by a connecting sleeve 25. When the motor 23 drives the first fan wheel 21 and the second fan wheel 22 to rotate, it may be ensured that the first fan wheel 21 and the second fan wheel 22 rotate synchronously through design of the connecting sleeve 25. In addition, FIG. 8 shows a schematic diagram of internal assembly of the fluid transportation device according to still another embodiment of the present invention without a second shell. With reference to FIG. 8, in still another embodiment, at least one guide blade 251 may be disposed on an outer peripheral surface of the connecting sleeve 25 of the fluid transportation device 1 of the present invention. Through design of the guide blade 251, the fluid pressurization and guide effect may be still effectively improved in combination with the pressurizing portion 16. With reference to FIG. 7 and FIG. 8, in an embodiment, at least one stationary blade 17 and at least one guide blade 251 may be disposed simultaneously for the fluid transportation device 1 of the present invention, to further improve the fluid pressurization and guide effect.

With reference to FIG. 3, in an embodiment, a sealing ring 18 may be disposed at a joint 19 between the first shell 11 and the second shell 12 of the fluid transportation device 1 of the present invention, to ensure that the first shell 11 and the second shell 12 after jointed have a better sealing effect.

As described above, in the foregoing embodiments, the fluid transportation device 1 of the present invention may provide better convenience in assembly and maintenance, and more efficiently control the fluid to flow circularly.

While several embodiments of the present disclosure have been illustrated and described, various modifications and improvements can be made by those skilled in the art. The embodiments of the present disclosure are therefore described in an illustrative but not in a restrictive sense. It is intended that the present disclosure should not be limited to the particular forms as illustrated and that all modifications which maintain the spirit and scope of the present disclosure are within the scope defined in the appended claims.

What is claimed is:

1. A fluid transportation device comprising:
a casing, having a first shell and a second shell divided along an axial direction, the first shell and the second shell assembled to be opposite to each other, and having an accommodating space, a first transporting portion and a second transporting portion, the first transporting portion and the second transporting portion being in communication with the accommodating space; and
a fluid driving member, having a first fan wheel, a second fan wheel, and a motor, the first fan wheel, the second fan wheel, and the motor disposed in the accommodating space, and the motor configured to drive the first fan wheel and the second fan wheel to rotate.

2. The fluid transportation device according to claim 1, wherein materials of the first shell and the second shell are the same.

3. The fluid transportation device according to claim 1, wherein materials of the first shell and the second shell are different.

4. The fluid transportation device according to claim 3, wherein the material of the first shell is a transparent material, and the second shell is made of a thermally conductive material.

5. The fluid transportation device according to claim 4, wherein a temperature sensing element and a light emitting element are disposed in the accommodating space of the casing, the light emitting element corresponds to the first shell, and the temperature sensing element is electrically coupled to a control element to control the light emitting element.

6. The fluid transportation device according to claim 4, further comprising a heat conducting portion disposed on an outer peripheral wall of the second shell.

7. The fluid transportation device according to claim 1, wherein the accommodating space comprises a first accommodating chamber, a second accommodating chamber, and a third accommodating chamber, in the axial direction, the second accommodating chamber is located between the first accommodating chamber and the third accommodating chamber, the first transporting portion is in communication with the first accommodating chamber, and the second transporting portion is in communication with the second accommodating chamber, the first fan wheel is disposed in the first accommodating chamber, the second fan wheel is disposed in the second accommodating chamber, and the motor is disposed in the third accommodating chamber.

8. The fluid transportation device according to claim 7, further comprising a pressurizing portion disposed in the first accommodating chamber of the casing, and the pressurizing portion correspondingly disposed around an outer periphery of the first fan wheel.

9. The fluid transportation device according to claim 8, further comprising a pressurizing channel disposed between the first accommodating chamber and the second accommodating chamber, wherein the casing has a first peripheral wall in the first accommodating chamber, and the first peripheral wall is tapered toward the pressurizing channel to jointly form the pressurizing portion.

10. The fluid transportation device according to claim 9, further comprising at least one stationary blade disposed on the first peripheral wall.

11. The fluid transportation device according to claim 9, wherein the first peripheral wall of the first accommodating chamber is an arc convex surface.

12. The fluid transportation device according to claim 7, wherein the casing has a second peripheral wall in the second chamber, in a direction perpendicular to the axial direction, there is a first distance between an outer periphery of the second fan wheel adjacent to the second transporting portion and the second peripheral wall, and there is a second distance between an outer periphery of the second fan wheel away from the second transporting portion and the second peripheral wall, the first distance is greater than the second distance.

13. The fluid transportation device according to claim 7, wherein the casing has a third peripheral wall in the third accommodating chamber, at least one first positioning portion is disposed on the third peripheral wall, and at least one second positioning portion is disposed on the motor, the first positioning portion and the second positioning portion are positioned corresponding to each other.

14. The fluid transportation device according to claim 13, wherein the first positioning portion and the second positioning portion are respectively planes that are abutted against each other.

15. The fluid transportation device according to claim 13, wherein the motor has a central shaft, a permanent magnet, and a stator, in the axial direction, two opposite ends of the central shaft are fixed in the accommodating space, the permanent magnet is combined with the first fan wheel and the second fan wheel.

16. The fluid transportation device according to claim 15, wherein the central shaft penetrates through the first fan wheel, the second fan wheel and the stator,

17. The fluid transportation device according to claim 15, wherein a radial cross section of the two opposite ends of the central shaft is a non-circular shape.

18. The fluid transportation device according to claim 15, further comprising a waterproof member covering the stator.

19. The fluid transportation device according to claim 18, further comprising a waterproof glue filling in the waterproof member, wherein the waterproof glue covers the stator.

20. The fluid transportation device according to claim 15, further comprising a waterproof glue covering the stator.

21. The fluid transportation device according to claim 18, wherein the second positioning portion is disposed on an outer peripheral wall of the waterproof member.

22. The fluid transportation device according to claim 18, wherein the waterproof member further comprises an accommodating groove to accommodate the permanent magnet.

23. The fluid transportation device according to claim 15, wherein the stator further comprises a power line, the second shell further comprises a line outlet, and the power line penetrates through the line outlet.

24. The fluid transportation device according to claim 15, wherein the first fan wheel and the second fan wheel are rotatably combined with the central shaft, and at least one bearing is disposed between the first fan wheel, the second fan wheel and the central shaft

25. The fluid transportation device according to claim 24, wherein the bearing is a plastic bearing or a ceramic bearing.

26. The fluid transportation device according to claim 7, wherein each the first fan wheel and the second fan wheel has an upper cover, a plurality of blades, and a lower cover, the plurality of blades are respectively disposed between the upper cover and the lower cover, each the upper covers of the first fan wheel and the second fan wheel forms an opening.

27. The fluid transportation device according to claim 26, wherein the first fan wheel and the second fan wheel are connected to each other by a connecting sleeve.

28. The fluid transportation device according to claim 27, wherein at least one guide blade is disposed on an outer peripheral surface of the connecting sleeve.

29. The fluid transportation device according to claim 26, wherein the first accommodating chamber of the casing comprises a first peripheral wall, at least one stationary blade is disposed on the first peripheral wall, the stationary blade has a stationary blade driving face, and the plurality of blades of the first fan wheel each has a dynamic blade driving face, the stationary blade driving face and the dynamic blade driving face are toward different directions.

30. The fluid transportation device according to claim 7, wherein the fluid driving member further comprises at least one additional fan wheel, the accommodating space further comprises at least one additional accommodating chamber, the at least one additional fan wheel is disposed in the at least one additional accommodating chamber.

31. The fluid transportation device according to claim 1, further comprising a sealing ring disposed at a joint between the first shell and the second shell.

32. The fluid transportation device according to claim 1, wherein the first transporting portion and the second transporting portion are pipes respectively, the pipes are able to be disassembled or assembled on the casing respectively, the pipes are disposed on the first shell.
